(19) United States
(12) Patent Application Publication
(10) Pub. No.: US 2025/0370539 A1
(43) Pub. Date: Dec. 4, 2025

(54) WEARABLE DEVICE AND COMMUNICATION METHOD

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW)

(73) Assignee: HTC Corporation, Taoyuan City (TW)

(21) Appl. No.: 19/199,497

(22) Filed: May 6, 2025

Related U.S. Application Data
(60) Provisional application No. 63/654,312, filed on May 31, 2024.

(30) Foreign Application Priority Data
Mar. 18, 2025 (TW) 114109988

(51) Int. Cl. G06F 3/01; G06F 1/16

(52) U.S. Cl. CPC G06F 3/015; G06F 1/163

(57) ABSTRACT

A wearable device includes a frame element, an extension element, a plurality of capacitive sensors, a plurality of bone conduction transducers, an antenna element, and a tuning circuit. The extension element is connected to the frame element. The capacitive sensors are disposed on the extension element, and are arranged along a first direction. The capacitive sensors can generate a first sensing signal relative to a human body portion. The bone conduction transducers are disposed on the extension element, and are arranged along a second direction. The bone conduction transducers can generate a second sensing signal relative to the human body portion. The antenna element is disposed on the frame element or the extension element. The tuning circuit is coupled to the antenna element. The tuning circuit can provide a variable impedance value according to the first sensing signal and the second sensing signal.

### CROSS REFERENCE TO RELATED APPLICATIONS

This application claims the benefit of U.S. Provisional Application No. 63/654,312, filed on May 31, 2024, and also claims priority of Taiwan Patent Application No. 114109988, filed on Mar. 18, 2025, the entirety of which are incorporated by reference herein.

### BACKGROUND OF THE INVENTION

### Field of the Invention

The invention relates to a wearable device, and more particularly, it relates to a wearable device and a communication method thereof.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHZ, 850 MHz, 900 MHz, 1800 MHZ, 1900 MHZ, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements for wireless communication. Because the user's own physical conditions are different, they may degrade the communication quality of the relative antennas. Accordingly, there is a need to propose a novel solution for solving the problem of the prior art.

### BRIEF SUMMARY OF THE INVENTION

In an exemplary embodiment, the invention is directed to a wearable device for detecting a human body portion. The wearable device includes a frame element, an extension element, a plurality of capacitive sensors, a plurality of bone conduction transducers, an antenna element, and a tuning circuit. The extension element is connected to the frame element. The capacitive sensors are disposed on the extension element, and are arranged along a first direction. The capacitive sensors can generate a first sensing signal relative to the human body portion. The bone conduction transducers are disposed on the extension element, and are arranged along a second direction. The bone conduction transducers can generate a second sensing signal relative to the human body portion. The antenna element is disposed on the frame element or the extension element. The tuning circuit is coupled to the antenna element. The tuning circuit can provide a variable impedance value according to the first sensing signal and the second sensing signal.

In some embodiments, the wearable device is a pair of smart eyeglasses with a function of wireless communication.

In some embodiments, the human body portion is an ear.

In some embodiments, the frame element is a glasses frame.

In some embodiments, the extension element is a temple.

In some embodiments, the extension element includes a main segment, a first branch and a second branch. Both the first branch and the second branch are connected to the main segment.

In some embodiments, the capacitive sensors are adjacent to the human body portion, and are distributed over the main segment and the first branch.

In some embodiments, the bone conduction transducers are adjacent to the human body portion, and are distributed over the first branch and the second branch.

In some embodiments, the distance between any adjacent two capacitive sensors is longer than or equal to 5 mm.

In some embodiments, the minimum distance between the capacitive sensors and the antenna element is shorter than or equal to 5 mm.

In some embodiments, the first direction and the second direction are different from each other.

In some embodiments, the second direction is substantially perpendicular to the first direction.

In some embodiments, the bone conduction transducers transmit an acoustic signal to the human body portion, and then receive an echo signal from the human body portion.

In some embodiments, the bone conduction transducers generate the second sensing signal according to the echo signal.

In some embodiments, the bone conduction transducers are operated in an initial mode or a normal mode.

In some embodiments, in the initial mode, the frequency of the acoustic signal is lower than or equal to 30 KHz.

In some embodiments, in the normal mode, the frequency of the acoustic signal is from 20 kHz to 30 kHz.

In another exemplary embodiment, the invention is directed to a communication method that includes the steps of: providing a frame element, an extension element, a plurality of capacitive sensors, a plurality of bone conduction transducers, an antenna element and a tuning circuit, wherein the extension element is connected to the frame element, wherein the capacitive sensors are disposed on the extension element and are arranged along a first direction, wherein the bone conduction transducers are disposed on the extension element and are arranged along a second direction, and wherein the tuning circuit is coupled to the antenna element; generating a first sensing signal relative to a human body portion by the capacitive sensors; generating a second sensing signal relative to the human body portion by the bone conduction transducers; and providing a variable impedance value according to the first sensing signal and the second sensing signal by the tuning circuit.

In some embodiments, the communication method further includes the step of transmitting an acoustic signal to the human body portion and then receiving an echo signal from the human body portion by the bone conduction transducers.

In some embodiments, the communication method further includes the step of generating the second sensing signal according to the echo signal by the bone conduction transducers.

### BRIEF DESCRIPTION OF DRAWINGS

The invention can be more fully understood by reading the subsequent detailed description and examples with references made to the accompanying drawings, wherein:

FIG. 1 is a diagram of a wearable device according to an embodiment of the invention;

FIG. 2 is a diagram of a wearable device according to an embodiment of the invention; and

FIG. 3 is a flowchart of a communication method according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

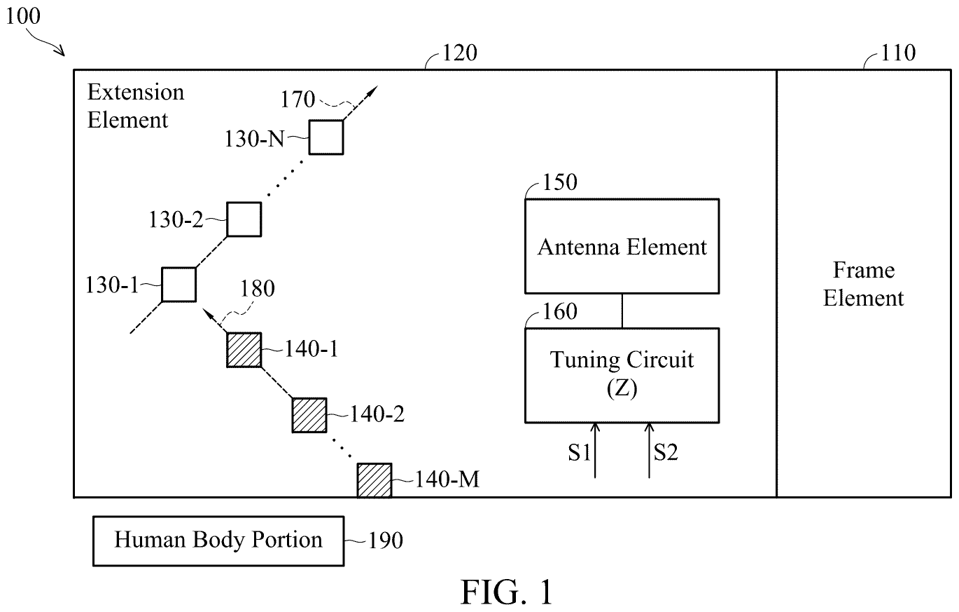

FIG. 1 is a diagram of a wearable device 100 according to an embodiment of the invention. For example, the wearable device 100 may be applied to the field of VR (Virtual Reality) or AR (Augmented Reality), but it is not limited thereto. As shown in FIG. 1, the wearable device 100 includes a frame element 110, an extension element 120, a plurality of capacitive sensors 130-1, 130-2, . . . , and 130-N, a plurality of bone conduction transducers 140-1, 140-2, . . . , and 140-M, an antenna element 150, and a tuning circuit 160, where each of “N” and “M” may be any integer greater than or equal to 2. It should be understood that the wearable device 100 may include other components, such as a transmission line, a signal source, an electrode, a battery, and/or a power supply module, although they are not displayed in FIG. 1.

In some embodiments, the wearable device 100 is configured to detect a human body portion 190. For example, the human body portion 190 may be a head or an ear of a user, but it is not limited thereto.

The shapes and the styles of the frame element 110 and the extension element 120 are not limited in the invention. The extension element 120 is connected to the frame element 110. The user can easily wear the wearable device 100 by using the frame element 110 and the extension element 120. In some embodiments, the frame element 110 and the extension element 120 are made of nonconductive materials, such as plastic materials. The capacitive sensors 130-1, 130-2, . . . , and 130-N and the bone conduction transducers 140-1, 140-2, . . . , and 140-M are disposed adjacent to the human body portion 190, and they are configured to collect a variety of information about the human body portion 190. It should also be noted that the term “adjacent” or “close” over the disclosure means that the distance (spacing) between two corresponding elements is smaller than a predetermined distance (e.g., 10 mm or the shorter), or means that the two corresponding elements directly touch each other (i.e., the aforementioned distance/spacing between them is reduced to 0).

The capacitive sensors 130-1, 130-2, . . . , and 130-N are disposed on the extension element 120, and are arranged along a first direction 170. The capacitive sensors 130-1, 130-2, . . . , and 130-N can generate a first sensing signal S1 relative to the human body portion 190.

The bone conduction transducers 140-1, 140-2, . . . , and 140-M are disposed on the extension element 120, and are arranged along a second direction 180. The bone conduction transducers 140-1, 140-2, . . . , and 140-M can generate a second sensing signal S2 relative to the human body portion 190. It should be noted that the first direction 170 and the second direction 180 are different from each other. For example, the second direction 180 may be substantially perpendicular to the first direction 170, but it is not limited thereto.

The antenna element 150 is disposed on the frame element 110 or the extension element 120. The antenna element 150 may be made of a metal material, such as copper, silver, aluminum, iron, or their alloys. In some embodiments, the antenna element 150 is a monopole antenna, a dipole antenna, a patch antenna, a loop antenna, a helical antenna, or a chip antenna, but it is not limited thereto.

The tuning circuit 160 is coupled to the capacitive sensors 130-1, 130-2, . . . , and 130-N, the bone conduction transducers 140-1, 140-2, . . . , and 140-M, and the antenna element 150. The tuning circuit 160 can provide a variable impedance value Z according to the first sensing signal S1 and the second sensing signal S2. For example, the variable impedance value Z may include a variable capacitance, a variable inductance, and/or a variable resistance.

With the design of the invention, the capacitive sensors 130-1, 130-2, . . . , and 130-N and the bone conduction transducers 140-1, 140-2, . . . , and 140-M can obtain the sensing signals corresponding to the human body portion 190 in different directions, so as to enhance the overall detection accuracy. Based on these sensing signals, the tuning circuit 160 can apply an appropriate impedance value to the antenna element 150, thereby improving the radiation performance of the antenna element 150. According to practical measurements, the proposed wearable device 100 can maintain relatively good communication quality even if it is worn by users with different conditions (e.g., these users may have different face shapes and different ear sizes). In alternative embodiments, the tuning circuit 160 can perform a 3D (Three-Dimensional) sound calibration process according to the first sensing signal S1 and the second sensing signal S2.

The following embodiments will introduce different configurations and detail structural features of the wearable device 100. It should be understood that these figures and descriptions are merely exemplary, rather than limitations of the invention.

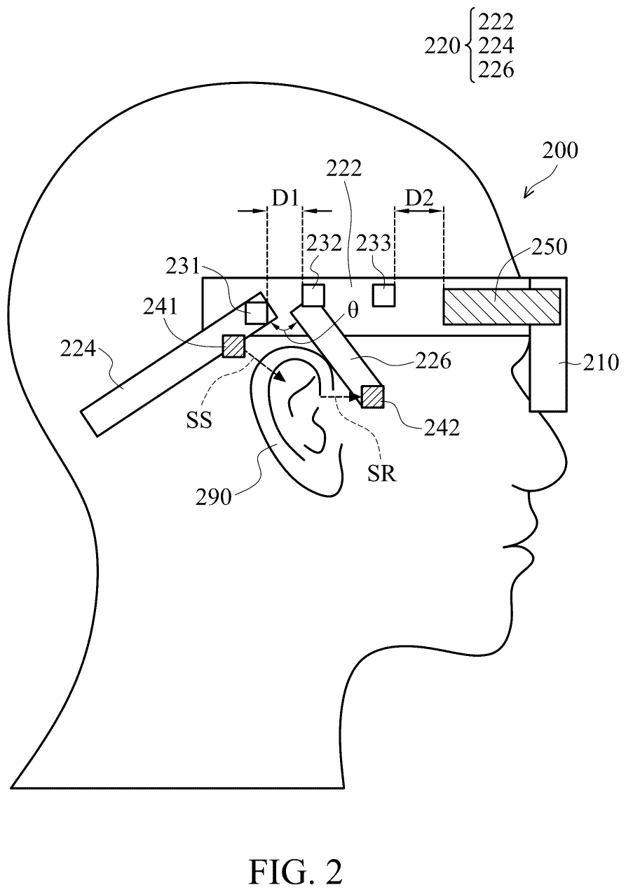

FIG. 2 is a diagram of a wearable device 200 according to an embodiment of the invention. FIG. 2 is similar to FIG. 1. In the embodiment of FIG. 2, the wearable device 200 is a pair of smart eyeglasses with the function of wireless communication, and the human body portion 290 detected by the wearable device 200 is an ear. Specifically, the wearable device 200 includes a frame element 210, an extension element 220, a plurality of capacitive sensors 231, 232 and 233, a plurality of bone conduction transducers 241 and 242, an antenna element 250, and a tuning circuit (not shown). For example, the frame element 210 may be a glasses frame, and the extension element 220 may be a temple. It should be understood that the number of capacitive sensors and the number of bone conduction transducers as mentioned above can be adjusted to meet various requirements. Also, the capacitive sensors and the bone conduction transducers may be symmetrically disposed on the left and right sides of the wearable device 200.

In some embodiments, the extension element 220 includes a main segment 222, a first branch 224, and a second branch 226. Both the first branch 224 and the second branch 226 are connected to the main segment 222. Furthermore, there may be an angle θ formed between the first branch 224 and the second branch 226, and the angle θ may be from 70 to 100 degrees (e.g., about 80, 90 or 95 degrees), but it is not limited thereto. In alternative embodiments, the extension element 220 does not include the first branch 224 or the second branch 226.

The capacitive sensors 231, 232 and 233 are adjacent to the human body portion 290, and are distributed over the main segment 222 and the first branch 224. For example, the first sensing signal generated by the capacitive sensors 231, 232 and 233 may include the information of ear contact pressure, but it is not limited thereto. In some embodiments, the distance D1 between any adjacent two of the capacitive sensors 231, 232 and 233 is longer than or equal to 5 mm, and the shortest distance D2 between the capacitive sensors 231, 232 and 233 and the antenna element 250 is shorter than or equal to 5 mm. According to practical measurements, the ranges of the distances D1 and D2 can help to enhance the detection accuracy of the wearable device 200, and also to improve the communication quality of the wearable device 200.

The bone conduction transducers 241 and 242 are adjacent to the human body portion 290. The bone conduction transducer 241 is distributed over the first branch 224. The bone conduction transducer 242 is distributed over the second branch 226. For example, the human body portion 290 may be positioned between the bone conduction transducers 241 and 242, but it is not limited thereto. The bone conduction transducers 241 and 242 can transmit an acoustic signal SS to the human body portion 290, and then receive an echo signal SR from the human body portion 290. The echo signal SR may record some physiological information about the human body portion 290, such as bone density at different relative positions. The bone density may affect some ultrasound parameters, such as SOS (Speed of Sound) and BUA (Broadband Ultrasound Attenuation). SOS and BUA may be theoretically used to estimate a displacement. Next, the bone conduction transducers 241 and 242 can generate a second sensing signal according to the echo signal SR. For example, the second sensing signal may include the information of facial bone shapes.

In some embodiments, the capacitive sensors 231, 232 and 233 are arranged along a first direction, and the bone conduction transducers 241 and 242 are arranged along a second direction. The first direction and the second direction may be different from each other.

In some embodiments, the bone conduction transducers 241 and 242 are operated in an initial mode or a normal mode. In the initial mode, the frequency of each of the acoustic signal SS and the echo signal SR may be lower than or equal to 30 kHz. In the normal mode, the frequency of each of the acoustic signal SS and the echo signal SR may be from 20 kHz to 30 kHz. For example, when the user wearing the wearable device 200 listens to music (i.e., in the normal mode), the bone conduction transducers 241 and 242 may continuously perform a detection process on the human body portion 290, without disturbing the user. Other features of the wearable device 200 of FIG. 2 are similar to those of the wearable device 100 of FIG. 1. Accordingly, the two embodiments can achieve similar levels of performance.

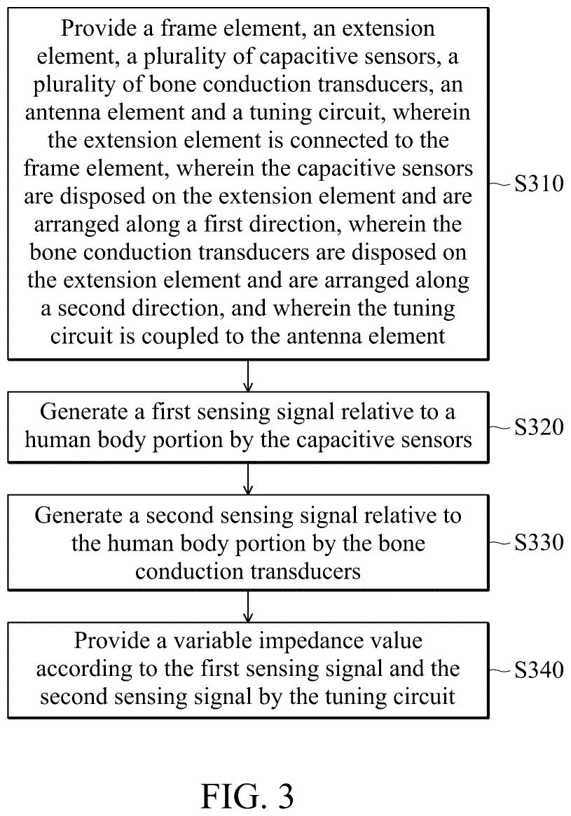

FIG. 3 is a flowchart of a communication method according to an embodiment of the invention. To begin, in step S310, a frame element, an extension element, a plurality of capacitive sensors, a plurality of bone conduction transducers, an antenna element, and a tuning circuit are provided. The extension element is connected to the frame element. The capacitive sensors are disposed on the extension element and are arranged along a first direction. The bone conduction transducers are disposed on the extension element and are arranged along a second direction. The tuning circuit is coupled to the antenna element. In step S320, a first sensing signal relative to a human body portion is generated by the capacitive sensors. In step S330, a second sensing signal relative to the human body portion is generated by the bone conduction transducers. Finally, in step S340, a variable impedance value is provided according to the first sensing signal and the second sensing signal by the tuning circuit. It should be understood that these steps are not required to be performed in order, and every feature of the embodiments of FIGS. 1 and 2 may be applied to the communication method of FIG. 3.

The invention proposes a novel wearable device. According to practical measurements, the wearable device using the above design can significantly improve its overall detection accuracy and its overall communication quality. Therefore, the invention is suitable for application in a variety of equipment.

Note that the above element sizes and element parameters are not limitations of the invention. A designer can fine-tune these setting values according to different requirements. It should be understood that the wearable device and the communication method of the invention are not limited to the configurations of FIGS. 1-3. The invention may include any one or more features of any one or more embodiments of FIGS. 1-3. In other words, not all of the features displayed in the figures should be implemented in the wearable device and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A wearable device for detecting a human body portion, comprising:
a frame element;
an extension element, connected to the frame element;
a plurality of capacitive sensors, disposed on the extension element, and arranged along a first direction, wherein the capacitive sensors generate a first sensing signal relative to the human body portion;
a plurality of bone conduction transducers, disposed on the extension element, and arranged along a second direction, wherein the bone conduction transducers generate a second sensing signal relative to the human body portion;
an antenna element, disposed on the frame element or the extension element; and
a tuning circuit, coupled to the antenna element, wherein the tuning circuit provides a variable impedance value according to the first sensing signal and the second sensing signal.

2. The wearable device as claimed in claim 1, wherein the wearable device is a pair of smart eyeglasses with a function of wireless communication.

3. The wearable device as claimed in claim 1, wherein the human body portion is an ear.

4. The wearable device as claimed in claim 1, wherein the frame element is a glasses frame.

5. The wearable device as claimed in claim 1, wherein the extension element is a temple.

6. The wearable device as claimed in claim 1, wherein the extension element comprises a main segment, a first branch and a second branch, and both the first branch and the second branch are connected to the main segment.

7. The wearable device as claimed in claim 6, wherein the capacitive sensors are adjacent to the human body portion, and are distributed over the main segment and the first branch.

8. The wearable device as claimed in claim 6, wherein the bone conduction transducers are adjacent to the human body portion, and are distributed over the first branch and the second branch.

9. The wearable device as claimed in claim 1, wherein a distance between any two adjacent capacitive sensors is longer than or equal to 5 mm.

10. The wearable device as claimed in claim 1, wherein a minimum distance between the capacitive sensors and the antenna element is shorter than or equal to 5 mm.

11. The wearable device as claimed in claim 1, wherein the first direction and the second direction are different from each other.

12. The wearable device as claimed in claim 1, wherein the second direction is substantially perpendicular to the first direction.

13. The wearable device as claimed in claim 1, wherein the bone conduction transducers transmit an acoustic signal to the human body portion, and then receive an echo signal from the human body portion.

14. The wearable device as claimed in claim 13, wherein the bone conduction transducers generate the second sensing signal according to the echo signal.

15. The wearable device as claimed in claim 13, wherein the bone conduction transducers are operated in an initial mode or a normal mode.

16. The wearable device as claimed in claim 15, wherein in the initial mode, a frequency of the acoustic signal is lower than or equal to 30 KHz.

17. The wearable device as claimed in claim 15, wherein in the normal mode, a frequency of the acoustic signal is from 20 kHz to 30 KHz.

18. A communication method, comprising the steps of:
providing a frame element, an extension element, a plurality of capacitive sensors, a plurality of bone conduction transducers, an antenna element and a tuning circuit, wherein the extension element is connected to the frame element, wherein the capacitive sensors are disposed on the extension element and are arranged along a first direction, wherein the bone conduction transducers are disposed on the extension element and are arranged along a second direction, and wherein the tuning circuit is coupled to the antenna element;
generating a first sensing signal relative to a human body portion by the capacitive sensors;
generating a second sensing signal relative to the human body portion by the bone conduction transducers; and
providing a variable impedance value according to the first sensing signal and the second sensing signal by the tuning circuit.

19. The communication method as claimed in claim 18, further comprising:
transmitting an acoustic signal to the human body portion and then receiving an echo signal from the human body portion by the bone conduction transducers.

20. The communication method as claimed in claim 19, further comprising:
generating the second sensing signal according to the echo signal by the bone conduction transducers.
